(19) United States
(12) Patent Application Publication
(10) Pub. No.: US 2006/0146822 A1
(43) Pub. Date: Jul. 6, 2006

(54) System, protocol and associated methods for wireless multimedia distribution

(76) Inventors: Mikolaj Kolakowski, Reda (PL); Jacek Wysoczynski, Banino (PL)

Correspondence Address: INTEL CORPORATION, P.O. BOX 5326, SANTA CLARA, CA, 95056-5326, US

(21) Appl. No.: 11/027,486

(22) Filed: Dec. 30, 2004

(51) Int. Cl. H04L 12/56; H04J 3/26

(52) U.S. Cl. 370/390; 370/394; 370/432

(57) ABSTRACT

A system, protocol and associated methods for wireless multimedia distribution are generally described herein.

### TECHNICAL FIELD

Embodiments of the invention are generally directed to wireless communication systems and, more particularly, to a system, protocol and associated methods for wireless multimedia distribution.

### BACKGROUND

Wireless communication channels are inherently lossy, i.e., there is a certain amount of information that once transmitted will be lost during transmission and/or receive processing of the wireless communication channel. Left unattended, this lost information (sometimes referred to as frames, packets, symbols, bits, etc., cumulatively referenced herein as datagrams) may well rise to the level where the amount of lost information has an adverse effect on the performance of the receiving device and/or associated application. In multimedia applications supporting the communication of audio, video, data or combinations thereof, this is especially true as information lost during wireless communication transmission may well result in a diminished user experience.

In a unicast communication environment, wherein a single source communicates with a single destination, media content lost due to dropped datagrams may be recoverable using conventional forward error correction and/or re-transmission techniques. Unfortunately, such conventional techniques are not readily adapted to a multicast, or point to multi-point communication environment.

### BRIEF DESCRIPTION OF THE DRAWINGS

Embodiments of the present invention are illustrated by way of example, and not by way of limitation, in the figures of the accompanying drawings in which like reference numerals refer to similar elements and in which:

FIG. 1 is a block diagram of an example communication system within which embodiments of the invention may be practiced;

FIG. 2 is a block diagram of an example content delivery system, according to one example embodiment;

FIG. 3 is a flow chart of an example method for providing multimedia content within a wireless communication system, according to but one embodiment;

FIG. 4 is a graphical representation of a communication flow diagram for providing multimedia content within a wireless communication system, according to one embodiment; and

FIG. 5 is a block diagram of an example article of manufacture including content which, when executed by an accessing machine, causes the machine to implement one or more aspects of embodiment(s) of the invention.

### DETAILED DESCRIPTION

Embodiments of a system, protocol and associated methods to provide multimedia content via a wireless communication system are generally presented. More specifically, a system, protocol and associated methods are disclosed herein that improve the reliability of a wireless multicast transmission of multimedia content (audio, video, data or any combination thereof) to one or more devices.

This improvement is achieved by recognizing that the distribution of media content typically consumes about one megabyte per second (1 Mb/s), while a wireless communication channel typically provides a physical bandwidth of between 2 and 54 Mb/s (e.g., in wireless local area network (WLAN) applications). To effectively utilize the heretofore underutilized bandwidth of the wireless communication channel to improve the reliability of a multicast transmission, a reliable multicast agent (RMA) is introduced herein.

As developed more fully below, an RMA introduced in the transmitter and receiver of a multicast channel will manage multicast communication and when dropped (or, unrecoverable) datagrams are detected, a secondary communication channel is dynamically established between the transmitter and affected receiver. According to one embodiment, the RMA establishes the secondary communication channel as a “virtual” channel within the previously underutilized bandwidth of the physical communication channel. According to one embodiment, the virtual channel is a unicast channel. The RMA may then selectively retransmit the dropped datagrams to the source via the secondary communication channel.

According to one embodiment, this secondary communication channel is implemented at the media access control (MAC) layer of the communication protocol stack in the source transmitter and the destination receiver, thereby offloading this responsibility from higher layers, e.g., the application layer. In this regard, the RMA disclosed herein may be implemented in support of legacy multimedia processing applications, thereby improving the perceived quality and reliability of such applications without a commensurate, costly upgrade of such applications.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

Example Communications Environment

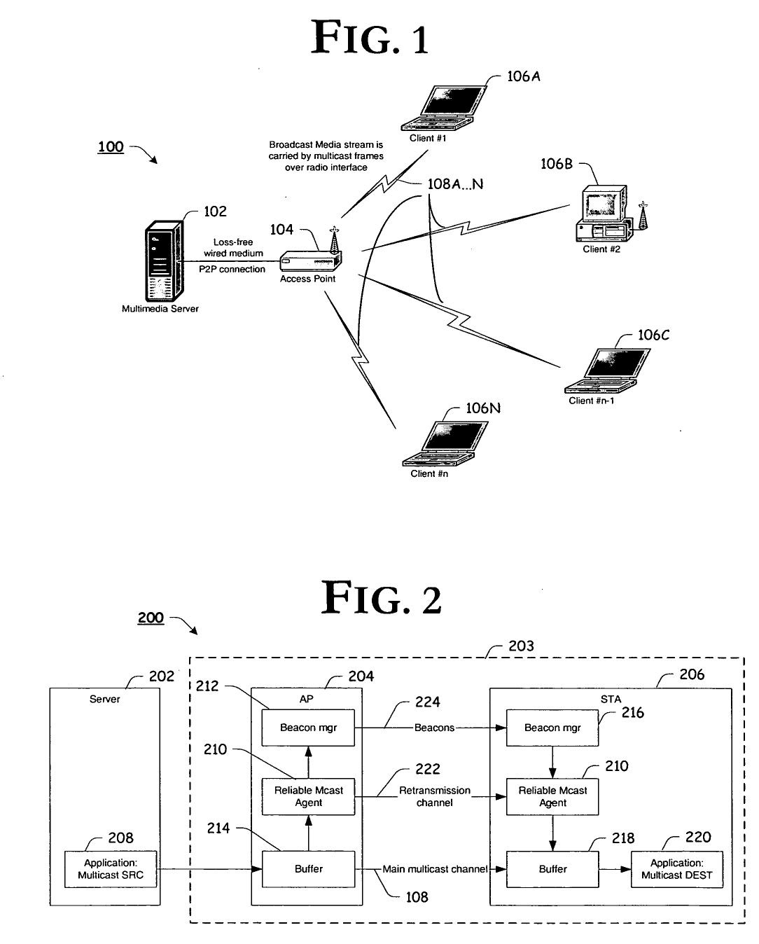

FIG. 1 illustrates a block diagram of an example wireless communication environment 100 within which embodiments of the invention may well be practiced. More particularly, FIG. 1 is depicted comprising one or more of a media content resource (e.g., a media delivery server) 102, and a plurality of wireless communication devices 104 and 106A . . . N, each coupled as depicted. According to one example embodiment, the content resource 102 provides media content to a first communication device 104 for wireless, multicast distribution to two or more remote communication devices 106A . . . N. According to one example embodiment, the wireless communications element (104-108) of environment 100 may be, without limitation, a wireless local area network (WLAN), wireless metropolitan area network (WMAN), a wireless personal area network (WPAN), a direct broadcast satellite (DBS) system and the like, although the invention is not limited in this regard.

For purposes of illustration, and not limitation, the wireless communication element (104-108) will be developed more fully in the context of an example WLAN implementation, although the invention is not limited in this regard. In accordance with such an example implementation, the WLAN distribution system may include an access point (AP) 104 communicatively coupled to one or more client stations (STA) 106A . . . N through one or more instances of a WLAN communication channel 108A . . . N. In this regard, WLAN distribution system 104-108 may operate in accordance with any one or more of the IEEE 802.11 and/or 802.16 communication standards¹, implementing an associated protocol, although the invention is not limited in this regard.
¹See, e.g., the IEEE 802.11, 1999 Edition; Information Technology Telecommunications and Information Exchange Between Systems—Local and Metropolitan Area Networks—Specific Requirements, Part 11: WLAN Medium Access Control (MAC) and Physical (PHY) Layer Specifications, its progeny and supplements thereto (e.g., 802.11a, .11g and .11n); see also the IEEE Std 802.16-2001 IEEE Std. 802.16-2001 IEEE Standard for Local and Metropolitan area networks Part 16: Air Interface for Fixed Broadband Wireless Access Systems, its progeny and supplements thereto (e.g., 802.16a, .16d, and .16e).

According to one example embodiment, device 104 and one or more of devices 106A . . . N may include the reliable multicast agent (RMA) (not particularly denoted in this view) introduced above. An RMA implemented in a transmitter-receiver pair may detect that some subset of the content initially sent via the multicast channel was lost in transmission, or is otherwise unrecoverable at the receiver. In response, the RMA may then coordinate the selective retransmission of the identified content to the select receiver(s) that would otherwise be lost in the multicast communication channel. Rather than retransmitting the content via the multicast channel, perhaps impairing the perceived quality of that communication channel, the RMA coordinates the selective retransmission via a dynamically established, secondary communication channel.

According to one embodiment, the secondary communication channel is a “virtual” unicast communication channel between the transmitter and the select receiver(s), although the scope of the invention is not limited in this regard. As used herein, the term virtual is intended to denote that a separate and distinct channel is established within a common physical channel. That is, the physical channel supports the multicast communication channel as well as the unicast, secondary channel.

According to one embodiment, the RMA coordinates buffering content received via the multicast channel and the secondary communication channel for promotion to a media processing application, ensuring that the media content is delivered to the application in the proper sequence, although the invention is not limited in this regard.

But for the selective inclusion of RMA and/or elements thereof, the devices 102-106 of communication environment 100 are intended to represent any of a wide range of electronic devices known in the art. In this regard, communication networks of greater or lesser complexity that nonetheless include the teachings of the RMA disclosed herein are intended to be captured by the scope and spirit of the claims, below.

Example Architecture(s)

Turning to FIG. 2, a block diagram of an example communication environment 200 is depicted through which multimedia content may be delivered according to embodiments of the invention. In accordance with the illustrated example embodiment of FIG. 2, communication environment 200 is depicted comprising one or more of a content resource 202 coupled to a wireless communication network 203 including at least a first wireless communication device 204 and a second wireless communication device 206, each coupled as depicted. For ease of illustration, and not limitation, the wireless communication network 203 of FIG. 2 merely depicts two devices, 204 and 206, engaged via a multicast communication channel 108, although the scope of the invention is not limited in this regard. As introduced above, wireless communication network 203 is intended to represent any of a wide range of wireless communication networks and associated protocols through which a multicast distribution channel may be established.

According to one embodiment, consistent with the example WLAN implementation of FIG. 1, the wireless communication network 203 may be utilized to distribute multimedia content received from a content resource 202 to one or more devices (e.g., 206) via a multicast communication channel 108. In this regard, content resource 202 may include an application 208 to provide media content to requesting devices, e.g., via a wireline communication medium, although the scope of the invention is not limited in this regard.

Device 204 is depicted comprising one or more of RMA(s) 210, beacon manager(s) 212 and buffer(s) 214, each logically coupled as depicted. According to one example embodiment consistent with the example WLAN implementation introduced above, device 204 may be an access point (AP) of wireless communication network 203, although the invention is not limited in this regard. According to one example embodiment, device 204 may be a block diagram representation of device 104.

According to one embodiment, RMA 210 may perform one or more management functions associated with the multicast distribution of media content (again, audio, video, data or any combination thereof). According to one embodiment, RMA 210 may be implemented as a feature in the media access control (MAC) layer of a wireless network interface (e.g., a transceiver), although the invention is not limited in this respect. In this regard, RMA 210 may control the flow of media content to the wireless multicast channel for transmission via the physical channel. As discussed below, RMA 210 may fragment, or parse, media content received in buffer 214 from content resource 202.

RMA 210 may then control reading of the media fragments from the buffer 214 to the multicast communication channel 108 for transmission to the remote wireless devices (e.g., 206). According to one embodiment, RMA 210 may generate a multicast announcement, which is passed to beacon manager 212 for inclusion as an information element in one or more beacons 224. According to one embodiment, the multicast announcement includes one or more of a destination addresses and sequence numbers of the buffered frames for each address, and a copy of the multicast announcement sent in a prior beacon (to enable retransmission to devices that may have missed the last beacon), although the invention is not limited in this regard.

According to one embodiment, as RMA 210 is reading media fragments out of the buffer for transmission via the multicast communication channel, it marks (e.g., via a header or other mechanism) the relative position of each fragment within a broader sequence of the content. In this regard, each fragment may be denoted by a sequence number, although the invention is not limited in this regard.

According to one embodiment, RMA 210 works in conjunction with a beacon manager 212 to manage and monitor the quality of the multicast transmission channel 108. Beacon manager 212 may function under the control of, or is integrated within RMA 210, although the invention is not limited as such. According to one embodiment, prior to or concurrently with the multicast transmission of one or more media fragments read from buffer 214, beacon manager 212 may issue a beacon signal 224 to devices within its coverage area of the wireless network 203. The beacons 224 may include one or more of source information, destination information and/or the sequence numbers of the fragments included within a current transmission window (e.g., bounded by time, bandwidth, space, etc.).

Device 206 is depicted comprising a complementary set of one or more of RMA(s) 210, beacon manager(s) 216, buffer(s) 218, each logically coupled as depicted. Consistent with an example WLAN implementation introduced above, device 206 may be a station (STA) within wireless communication network 203, although the scope of the invention is not so limited. According to one example embodiment, device 206 may be a block diagram representation of one or more of devices 106A . . . N.

According to one embodiment, device 206 may also include a destination application 220, to receive the content sourced from content resource 202. According to one embodiment, application(s) 220 may be a media player to render multimedia content for the enjoyment of an end-user of device 206, although the scope of the invention is not limited to such an implementation.

As above, RMA 210 in a receiving device (e.g., 206) may perform operations/functions that are complementary to that of the transmitting RMA 210 (e.g., in device 204). In this regard, beacon manager 216 may receive and decode beacons 224 to recover one or more of source information, destination information and/or sequence number information, at least a subset of which is provided to RMA 210. The sequence number information provides a listing of media fragments that have been sent by the transmitting device (204) and should be contained within the receive buffer 218.

) RMA 210 of device 206 may monitor the media fragments populating buffer 218, and confirms that the sequence numbers match those received via the beacons 224. According to one embodiment, RMA 210 of device 206 may monitor the sequence numbers of the information (e.g., media fragments) as they are written into buffer 218. Alternatively, RMA 210 of device 206 may interrogate buffer 218 to identify the sequence numbers of the information stored therein, or may monitor the information as it is read out of the buffer, although the invention is not limited in this regard. Accordingly, RMA 210 of device 206 may compare the sequence numbers of the information received via the multicast channel 108 against the sequence numbers received in the beacons 224 to identify dropped/unrecoverable information.

According to one embodiment, RMA 210 and/or beacon manager 216 will buffer at least a subset of the information received via the beacons during the transmission window, or until the information associated with the sequence numbers embedded within the received beacons 224 is confirmed received. As introduced above, the transmission window may be defined in time, space, bandwidth, etc., although the invention is not so limited. If information associated with one or more sequence numbers embedded within the received beacons 224 are not confirmed as received either before they are needed (e.g., by application 220), or by the expiration of the transmission window, RMA 210 in device 206 may issue a retransmission request to RMA 210 in the source device (204). According to one embodiment, the retransmission request includes a list of one or more sequence numbers requested for retransmission.

According to one embodiment, upon receiving a retransmission request, RMA 210 may establish a secondary communication channel 222 through which to retransmit the information associated with the sequence number(s) provided in the retransmission request. As introduced above, the secondary communication channel 222 may be a virtual, unicast communication channel (i.e., particularly denoting the destination address of the requesting device). According to one example embodiment, the unicast communication channel supplements the multicast communication channel 108 with retransmitted information that would otherwise be lost during transmission via the multicast channel 108, or during receive processing at the destination device (206). Unlike the multicast communication channel, the retransmission content in the secondary communication channel 222 may include a destination identifier associated with but a single device (e.g., a requesting device 206), although the invention is not so limited. More particularly, RMA 210 in device 204 reads the requested information (denoted by sequence number) out of buffer 214 (if still available) for retransmission via the secondary communication channel 222.

According to one embodiment, the RMA 210 may be implemented as a feature of the MAC. In this regard, RMA 210 may well be implemented in hardware, software, firmware, or any combination thereof without limitation. According to one embodiment, RMA 210 is implemented within a wireless communication chipset, although the invention is not limited in this regard.

Although not particularly denoted, those skilled in the art will appreciate that the devices (e.g., 204, 206) of the wireless communication network 203 may also include wireless transmitter and wireless receiver (cumulatively, transceiver) capability to effect the wireless communication link in accordance with one or more wireless communication protocols introduced above. But for the introduction of the RMA functionality and features disclosed herein, any of a range of transmitter and receiver architectures may well be used in accordance with the teachings of the present invention. In addition to the transceiver functionality (not particularly denoted), devices (e.g., 204, 206) of the wireless communication network 203 may include one or more antenna(e) such as, e.g., substantially omnidirectional antenna(e), directional antenna(e), and the like.

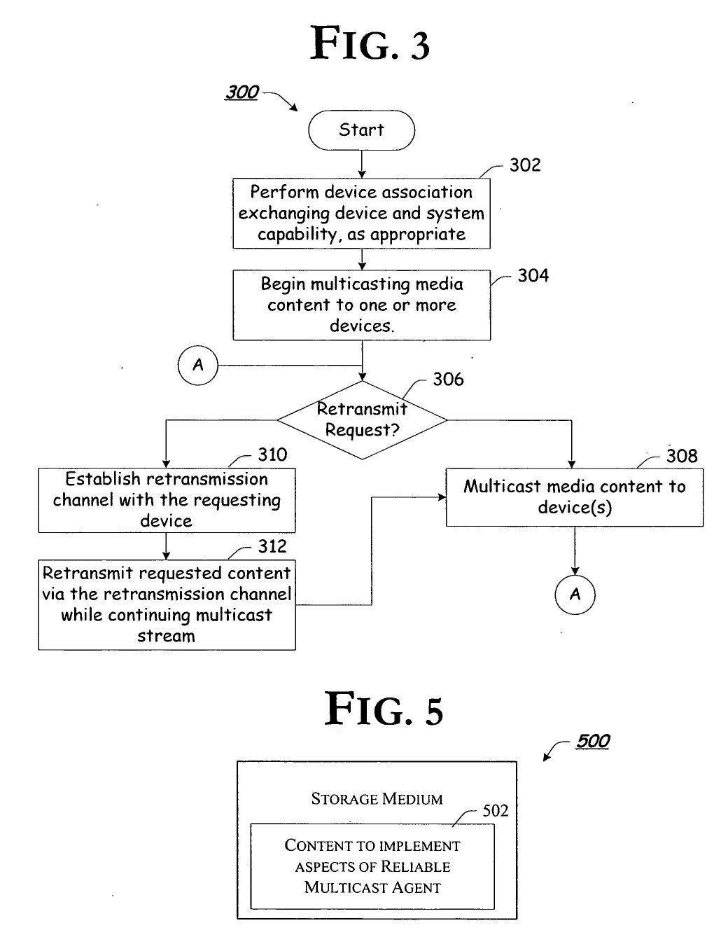

Having introduced the operating environment and logical relationship between various elements of the system in FIGS. 1 and 2, attention is now directed to FIG. 3, where an example method for the reliable multicast of content using RMA 210 is described, according to but one embodiment.

Example Operation

With continued reference to FIGS. 1 and 2, an example method for reliable wireless multicast communication is generally presented with reference to FIG. 3, according to but one example embodiment.

In accordance with the illustrated example embodiment of FIG. 3, the method begins with block 302 where one or more device(s) (e.g., 104, 106A . . . N) within a wireless communication network perform device association. According to one example embodiment, at least a subset of devices (204, 206) within the communication network exchange information denoting device capability including, for example, whether the particular device(s) include RMA capability.

In block 304 a multicasting session may begin. According to one embodiment, the multicasting session may begin during or subsequent to the association phase. According to one embodiment, content is sourced from a content resource, e.g., media server 202 via application 208, to a wireless transmitter of the multicast channel, e.g., device 204.

As introduced above, an RMA 210 in device 204 may fragment the content for transmission via the multicast communication channel 108 to one or more remote devices (e.g., 206). Such multicast transmission continues, block 308) until an RMA 210 (e.g., in a receiving device) detects the loss of informational content, block 306. As above, the lost content may be detected by the identification of missing sequence numbers associated with the received content.

If RMA 210 detects lost content it may cause a retransmission request to be issued, block 306. According to one embodiment, the retransmission request is a MAC layer message transmit from the receiving device 206 to the source of the multicast communication channel 108, device 204.

In response to the retransmission request, RMA 210 in device 204 dynamically establishes a secondary, retransmission channel 222 with the requesting device 206, block 310. As introduced above, RMA 210 in device 204 may read informational content from buffer 214 associated with the requested sequence numbers. The read informational content is formatted by RMA 210 in device 204 into unicast data packets for transmission via the secondary communication channel 222 to the requesting device 206. According to one example embodiment the secondary communication channel 222 is a virtual channel, utilizing un(der)-utilized bandwidth of a physical wireless communication link supporting the multicast communication channel 108.

In block 310, RMA 210 in device 204 may retransmit the requested content via the secondary communication channel 222. According to one embodiment, RMA 210 in device 204 may support several secondary communication channel(s) with disparate receiving device(s) (e.g., 206) while continuing to support multicast communication via the multicast communication channel. Upon receiving the missing frames, RMA 210 in the receiving device 206 may reorder the fragments to achieve proper order, e.g., according to sequence number.

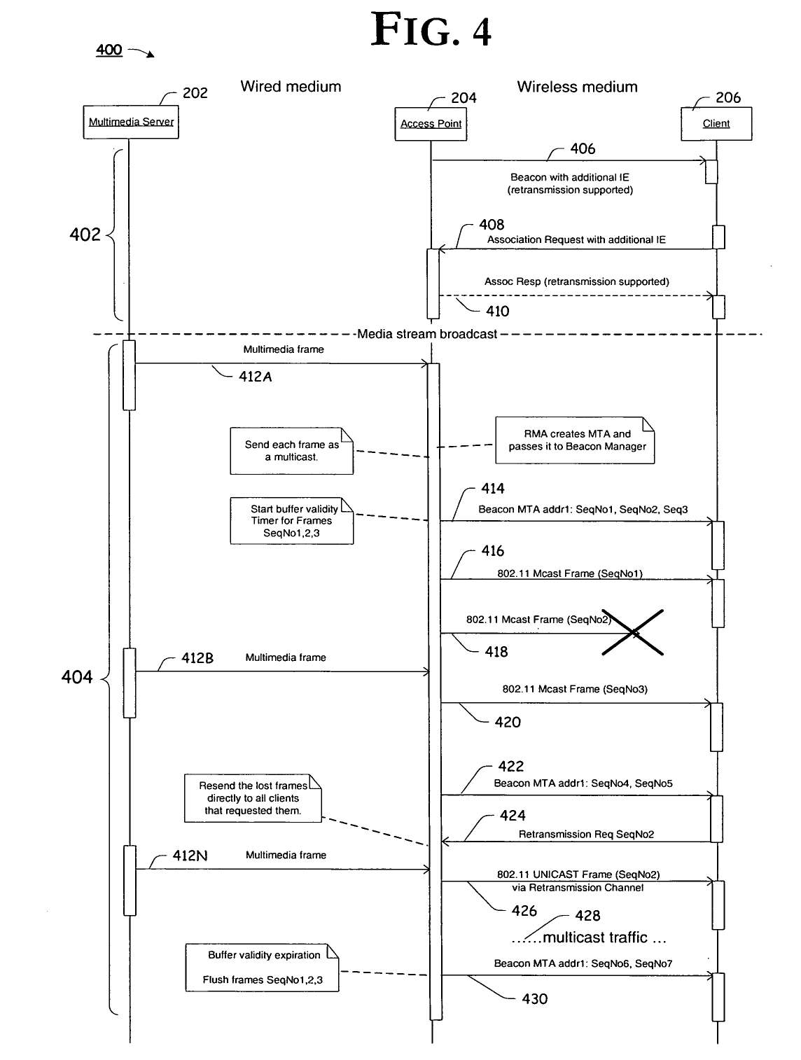

Turning briefly to FIG. 4, a communication flow diagram 400 of an example implementation of the RMA 210 is provided, according to one example embodiment. As shown, the communication flow diagram 400 is generally divided into two sections, or phases: an association phase 402 and a multicast phase 404, although the invention is not limited in this regard. For ease of explanation, and not limitation, the communication flow diagram will be developed within the context of an example WLAN communication environment.

As introduced above, during the association phase 402 (block 302 of FIG. 3), an access point 204 issues a beacon 406 to one or more remote devices (e.g., 206). According to one aspect of the invention, RMA 210 in device 204 may generate a multicast announcement that is forwarded to a beacon manager 212. Beacon manager 212 then generates a beacon message for transmission to the remote stations. As introduced above, the beacons 406 may include an information element denoting that device 204 supports RMA retransmission capability.

In response to receipt of the beacon(s) 406, one or more of the multicast target device(s) (e.g., 206) issues an association request 408. As above, the RMA 210 receives at least a subset of the informational content received via beacon manager 216, and then generates the response 408. According to one embodiment, the response 408 includes an information element denoting that device 206 supports RMA retransmission capability.

Device 204 receives the association request 408, whereupon at least a subset of the content of the request 408 is passed to RMA 210. In response, RMA 210 in device 204 generates an association response 410 denoting that retransmission is enabled as between the two devices 204, 206.

During or subsequent to the association phase 402, the content resource 202 may begin transmitting content 412a . . . n to device 204. As provided above, the communication medium between the content resource 202 and device 204 may well be one or more of a wired communication medium, a wireless communication medium and/or an optical communication medium and may actually traverse many different networks between such devices.

As introduced above, RMA 210 in device 204 may generate a multicast announcement for transmission in one or more beacons by beacon manager 212. RMA 210 in device 204 begins to parse, or fragment the received media content as it is read into buffer 218. According to one embodiment, RMA 210 may initialize a buffer validity timer to track the “age” of the contents in the buffer. According to one embodiment, the buffer may be flushed after the timer expires to make room for new content, although the invention is not limited in this respect.

Once beacon manager 214 receives the multicast announcement from RMA 210, it generates a beacon 414 for transmission to the remote devices initiating the multicast session. According to one embodiment, the beacon 414 may include one or more of a source address, destination address(es), and sequence number(s) of the content to be delivered via the multicast channel(s).

Commensurate with or subsequent to transmission of beacon 414, RMA 210 of device 204 initiates multicast transmission of media content via the multicast channel 416. According to one embodiment, the content is transmitted on a frame-by-frame basis (where the fragment size is a frame) in a sequential fashion, although the invention is not limited in this regard.

Multicast transmission continues until a lost frame 418 is identified. As introduced above, the identification of the lost frame may arise by receiving another multicast fragment 420 out of order, or failing to receive a multicast fragment 418 within a multicast transmission window, e.g., defined by time, space, bandwidth, etc., or the receipt of a subsequent beacon 422.

In response, RMA 210 in device 206 may generate and issue a retransmission request 424. As provided above, the retransmission request 424 may include one or more of the address of the requesting entity, the address of the source device (204) and/or the sequence number (e.g., 2) associated with the lost information.

In response to receiving a retransmission request, RMA 210 in device 204 may establish a secondary communication channel 426 through which to transmit the requested information (e.g., associated with sequence number 2). More particularly, RMA 210 attempts to identify the requested information (Seq. No. 2) in buffer 214 for retransmission. Assuming the buffer validity timer has not yet expired, causing the buffer to be flushed, RMA 210 in device 204 generates a unicast frame 426 for transmission to device 206. As introduced above, retransmission via the secondary communication channel 426 may occur simultaneously with continued multicast 428 and beacon 430 communication traffic, although the scope of the invention is not limited in this regard.

By providing support for an alternate, reliable means of retransmitting informational content that would otherwise be lost to, or unrecoverable from the lossy wireless communication channel supporting the multicast distribution of such media content, the RMA may significantly improve the user experience associated with wireless communication applications.

### Alternate Embodiment(s)

FIG. 5 illustrates a block diagram of an example storage medium comprising content which, when invoked, may cause an accessing machine to implement one or more aspects of the RMA 210 and/or associated methods 300, 400. In this regard, storage medium 500 may include content 502 (e.g., instructions, data, or any combination thereof) which, when executed, causes an accessing appliance to implement one or more aspects of the RMA 210 described above.

The machine-readable (storage) medium 500 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection). As used herein, all of such media is broadly considered storage media.

It should be understood that embodiments of the present invention may be used in a variety of applications. Although the present invention is not limited in this respect, the circuits disclosed herein may be used in many apparatuses such as in the transmitters and receivers of a radio system. Radio systems intended to be included within the scope of the present invention include, by way of example only, wireless local area networks (WLAN) devices and wireless wide area network (WWAN) devices including wireless network interface devices and network interface cards (NICs), base stations, access points (APs), gateways, bridges, hubs, cellular radiotelephone communication systems, satellite communication systems, two-way radio communication systems, one-way pagers, two-way pagers, personal communication systems (PCS), personal computers (PCs), personal digital assistants (PDAs), sensor networks, personal area networks (PANs) and the like, although the scope of the invention is not limited in this respect. Such devices may well be employed within any of a variety of

Embodiments of the present invention may also be included in integrated circuit blocks referred to as core memory, cache memory, or other types of memory that store electronic instructions to be executed by the microprocessor or store data that may be used in arithmetic operations. In general, an embodiment using multistage domino logic in accordance with the claimed subject matter may provide a benefit to microprocessors, and in particular, may be incorporated into an address decoder for a memory device. Note that the embodiments may be integrated into radio systems or hand-held portable devices, especially when devices depend on reduced power consumption. Thus, laptop computers, cellular radiotelephone communication systems, two-way radio communication systems, one-way pagers, two-way pagers, personal communication systems (PCS), personal digital assistants (PDA's), cameras and other products are intended to be included within the scope of the present invention.

The present invention includes various operations. The operations of the present invention may be performed by hardware components, or may be embodied in machine-executable content (e.g., instructions), which may be used to cause a general-purpose or special-purpose processor or logic circuits programmed with the instructions to perform the operations. Alternatively, the operations may be performed by a combination of hardware and software. Moreover, although the invention has been described in the context of a computing appliance, those skilled in the art will appreciate that such functionality may well be embodied in any of number of alternate embodiments such as, for example, integrated within a communication appliance (e.g., a cellular telephone).

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Any number of variations of the inventive concept are anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

What is claimed is:

1. A method comprising:
transmitting informational content to one or more remote devices through a multicast communication channel over a wireless communication link; and
selectively retransmitting some subset of the informational content to a subset of the one or more remote devices through a unicast communication channel over the wireless communication link upon request.

2. A method according to claim 1, further comprising:
receiving the informational content and parsing it into two or more fragments, each fragment denoted by a sequence number.

3. A method according to claim 2, further comprising:
generating a multicast announcement for transmission to the one or more remote devices through a beacon over the wireless communication link, the multicast announcement including sequence number information associated with upcoming multicast transmissions.

4. A method according to claim 3, further comprising:
receiving a retransmission request from a device denoting a failure to receive at least a subset of the informational content transmitted via the multicast communication channel.

5. A method according to claim 4, wherein the retransmission request includes one or more sequence number(s) associated with the subset of the informational content.

6. A method according to claim 5, further comprising:
generating a message for transmission via the unicast communication channel by reading one or more informational fragment(s) from the buffer associated with the requested sequence number(s).

7. A storage medium comprising content which, when executed causes an accessing device to implement a method according to claim 1.

8. A device comprising:
a reliable multicast agent (RMA), to transmit informational content to one or more remote devices through a multicast communication channel over a wireless communication link, and to selectively retransmit some subset of the informational content to a subset of the one or more remote devices through a unicast communication channel over the wireless communication link upon request.

9. A device according to claim 8, the RMA to receive the informational content and parse it into two or more fragments, each fragment denoted by a sequence number for storage in a buffer.

10. A device according to claim 9, wherein the RMA generates a multicast announcement for transmission to the one or more remote devices through a beacon over the wireless communication link, the multicast announcement including sequence number information associated with upcoming multicast transmissions.

11. A device according to claim 10, the RMA to receive a retransmission request from a device denoting a failure to receive at least a subset of the informational content transmitted via the multicast communication channel.

12. A device according to claim 11, wherein the retransmission request includes one or more sequence number(s) associated with the subset of the informational content.

13. A device according to claim 12, the RMA to generate a message for transmission via the unicast communication channel by reading one or more informational fragment(s) from the buffer associated with the requested sequence number(s).

14. A device according to claim 8, further comprising:
a wireless transceiver, responsive to the RMA, through which the wireless communication link between the device and a remote device.

15. A device according to claim 14, further comprising:
One or more substantially omnidirectional antenna(e), responsive to the wireless transceiver, to support transmission and reception of the wireless communication link.

16. A system comprising:
a reliable multicast agent (RMA), to transmit informational content to one or more remote devices through a multicast communication channel over a wireless communication link, and to selectively retransmit some subset of the informational content to a subset of the one or more remote devices through a unicast communication channel over the wireless communication link upon request; and
one or more substantially omnidirectional antenna(e), through which the RMA may establish the multicast communication channel and the unicast communication channel over the wireless communication link with the remote device(s).

17. A system according to claim 16, the RMA to receive the informational content and parse it into two or more fragments, each fragment denoted by a sequence number for storage in a buffer.

18. A system according to claim 17, wherein the RMA generates a multicast announcement for transmission to the one or more remote devices through a beacon over the wireless communication link, the multicast announcement including sequence number information associated with upcoming multicast transmissions.

19. A system according to claim 18, the RMA to receive a retransmission request from a device denoting a failure to receive at least a subset of the informational content transmitted via the multicast communication channel.

20. A system according to claim 19, wherein the retransmission request includes one or more sequence number(s) associated with the subset of the informational content.

21. A system according to claim 20, the RMA to generate a message for transmission via the unicast communication channel by reading one or more informational fragment(s) from the buffer associated with the requested sequence number(s).
